(19) United States
(12) Patent Application Publication
(10) Pub. No.: US 2002/0091527 A1
(43) Pub. Date: Jul. 11, 2002

(54) Distributed speech recognition server system for mobile internet/intranet communication

(76) Inventor: Shyue-Chin Shiau, Cupertino, CA (US)

Correspondence Address: Mitchell P. Brook, Baker & McKenzie, 101 W est Broadway,, Twelfth Floor, San Diego, CA, 92101, US

(21) Appl. No.: 09/757,305

(22) Filed: Jan. 8, 2001

(51) Int. Cl. G10L 21/00

(52) U.S. Cl. 704/270.1

(57) ABSTRACT

This invention is a speech recognition server system for implementation in a communications network having a plurality of clients, at least one site communication server, at least one contents server, and at least one communications gateway server, said speech recognition server system comprising a site map including a table of site address words; a speech server daemon, communicable with the wireless communications gateway server and the site communications server, for managing speech information; a voice recognition server, communicable with said speech server daemon, for speech recognition of the speech information; a site map manager, communicable with said site map, for speech recognition of the site address words in said site map; a speaker model, communicable with said site map manager and said voice recognition server, for speech recognition of the site address words in said site map; and a site selector, communicable with said voice recognition server, said speech server daemon, and said site map, for selecting the site words responsive to words recognized by said voice recognition server.

### FIELD OF THE INVENTION

This invention relates generally to speech recognition systems and more specifically to a distributed speech recognition server system for wireless mobile Internet/Intranet communications.

### BACKGROUND OF THE INVENTION

Transmission of information from humans to machines has been traditionally achieved though manually-operated keyboards, which presupposes machines having dimensions at least as large as the comfortable finger-spread of two human hands. With the advent of electronic devices requiring information input but which are smaller than traditional personal computers, the information input began to take other forms, such as menu item selection by pen pointing and icon touch screens. The information capable of being transmitted by pen-pointing and touch screens is limited by what can be comfortably displayed on devices such as personal digital assistants (PDAs) and mobile phones. Other methods such as handwriting recognition have been fraught with difficulties of accurate recognition. Therefore, automatic speech recognition has been the object of continuing research.

Systems relying on the human voice for information input, because of the inherent vagaries of speech (including homophones, word similarity, accent, sound level, syllabic emphasis, speech pattern, background noise, and so on), require considerable signal processing power and large look-up table databases in order to attain even minimal levels of accuracy. Mainframe computers and high-end workstations are beginning to approach acceptable levels of voice recognition, but even with the memory and computational power available in present personal computers (PCs), speech recognition for those machines is so far largely limited to given sets of specific voice commands. For devices with far less memory and processing power than PCs, such as PDAs, mobile phones, toys, and entertainment devices, accurate recognition of natural speech has been hitherto impossible. For example, a typical voice-dial cellular phone requires preprogramming by reciting a name and then entering an associated number and is heavily speaker-dependent. When the user subsequently recites the name, a microprocessor in the cell phone will attempt to match the recited name's voice pattern with the stored number. As anyone who has used present day voice-dial cell phones knows, the match is often inaccurate and only about 25 stored numbers are possible. In PDA devices, it is necessary for device manufacturers to perform extensive redesign to achieve even very limited voice recognition (for example, present PDAs cannot search a database in response to voice input).

Of particular present day interest is mobile Internet communication utilizing mobile phones, PDAs, sub-notebook/palmtop computers, and other portable electronic devices to access the Internet. The Wireless Application Protocol (WAP) defines an open, standard architecture and set of protocols for wireless Internet access. WAP consists of the Wireless Application Environment (WAE), the Wireless Session Protocol (WSP), the Wireless Transport Protocol (WTP), and the Wireless Transport Layer Security (WLS). WAE displays content on the screen of the mobile device and includes the Wireless Markup Language (WML), which is the presentation standard for mobile Internet applications. WAP-enabled mobile devices include a microbrowser to display WML content. WML is a modified subset of the Web markup language Hypertext Markup Language (HTML), scaled appropriately to meet the physical constraints and data capabilities of present day mobile devices, for example the Global System for Mobile (GSM) phones. Typically, the HTML served by a Web site passes through a WML gateway to be scaled and formatted for the mobile device. The WSP establishes and closes connections with WAP web sites, the WTP directs and transports the data packets, and the WLS compresses and encrypts the data sent from the mobile device. Communication from the mobile device to a web site that supports WAP utilizes the Universal Resource Locators (URL) to find the site, is transmitted via radio waves to the nearest cell and routed through the Internet to a gateway server. The gateway server translates the communication content into the standard HTTP format and transmits it to the website. The website response returns HTML documents to the gateway server which converts the content to WML and routes to the nearest antenna which transmits the content via radio waves to the mobile device. The content available for WAP currently includes email, news, weather, financial information, book ordering, investing services, and other information. Mobile phones with built-in Global Positioning System (GPS) receivers can pinpoint the mobile device user's position so that proximate restaurant and navigation information can be received. A Global System for Mobile (GSM) system consists of a plurality of Base Station Subsystems (BSS), and each Base Station Subsystem (BSS) is composed of several cells having its specific coverage area related to the physical location and the antenna direction of the Base Station Subsystems (BSS). When a cell phone is making a phone call or sending a short message, it must locate in the coverage area of one cell. By mapping the cell database and Cell ID, the area where the cell phone is located is known. This is called Cell Global Identity (CGI).

Wireless mobile Internet access is widespread in Japan and Scandinavia and demand is steadily increasing elsewhere. It has been predicted that over one billion mobile phones with Internet access capability will be sold in the year 2005. Efficient mobile Internet access, however, will require new technologies. Data transmission rate improvements such as the General Packet Radio Service (GPRS), Enhanced Data Rates for GSM Evolution (EDGE), and the Third Generation Universal Mobile Telecommunications System (3G-UMTS) are underway. But however much the transmission rates and bandwidth increase, how well the content is reduced or compressed, and the display capabilities modified, the vexing problem of information input and transmission at the mobile device end has not been solved. For example, just the keying in of an often very obscure website address is a tedious and error-prone exercise. For PDAs, a stylus can be used to tap in alphanumeric entries on a software keyboard, but this is a slow and cumbersome process. The 10-key keypad of mobile phones offers an even greater challenge as it was never designed for word input. A typical entry of a single word can require 25 keystrokes due to the three or four letters for each key and, as everyone has no doubt experienced, a mistake halfway through the entry process obviates the effort and the user must start anew. But at least entry is possible for alphabet-based languages; for symbol-based languages such as Chinese, Japanese, and Korean, keypad entry is almost impossible. Handwriting recognition systems have been developed to overcome this problem, but, as the well-documented problems of Apple's Newton™ showed, a universally usable handwriting entry system may be practically impossible. DoCoMo's i-Mode™ utilizes cHTML and a menu-driven interactive communication regime. That is, information or sites must be on the menu in order for the user to access it. This necessarily limits the generality of the information accessible. Microsoft's Mobile Explorer™ provides Internet browsing for mobile phones, but also suffers from lack of generality of information access. Thus it appears that speech input is the only feasible means for providing generally usable information input for mobile phones and PDAs. One approach has been voice portals, but voice portals have had the problems of high speech recognition computation demands, high transmission error rates, and high costs and complexities. The principal disadvantage of voice portals is the large expense required for scalability; for example, for 1,000 access lines, the cost for the additional ports (which require purchasing servers and associated software) is about $2,000,000. Scalability is essential for the voice portal to avoid busy signals, especially during peak use hours.

### SUMMARY OF THE INVENTION

There is a need, therefore, for an accurate speech recognition system for portable devices communicating over network communications systems such as the Internet or private intranets. The present invention is a speech recognition server system for implementation in a communications network having a plurality of clients, at least one site communication server, at least one contents server, and at least one communications gateway server, said speech recognition server system comprising a site map including a table of site address words; a speech server daemon, communicable with the wireless communications gateway server and the site communications server, for managing speech information; a voice recognition server, communicable with said speech server daemon, for speech recognition of the speech information; a site map manager, communicable with said site map, for speech recognition of the site address words in said site map; a speaker model, communicable with said site map manager and said voice recognition server, for speech recognition of the site address words in said site map; and a site selector, communicable with said voice recognition server, said speech server daemon, and said site map, for selecting the site words responsive to words recognized by said voice recognition server.

### BRIEF DESCRIPTION OF THE DRAWINGS

FIG. 1 illustrates a communication system wherein mobile devices utilize speech recognition to communicate via a wireless network with Internet websites and corporate intranets according to the present invention.

FIG. 2 is a block diagram of a distributed speech recognition system for wireless communications with the Internet according to the present invention.

FIG. 3 is a block diagram of a Internet/Intranet speech recognition communication system according to the present invention.

FIG. 4 is a block diagram showing a communications protocol system according to the present invention.

FIG. 5 shows an example of a data structure in an exemplary content provider server according to the present invention.

FIG. 6 is a block diagram of a server architecture according to the present invention.

FIG. 7 is a diagram illustrating a client-server communications scheme according to the present invention.

FIG. 8 is a schematic diagram of VerbalWAP server daemon architecture. according to the present invention.

FIG. 9 is a schematic diagram illustrating a supervised adaptation session according to the present invention.

FIG. 10 is a schematic representation of a voice recognition server including a voice recognition engine according to the present invention.

FIG. 11 is a schematic diagram of a sitemap management architecture according to the present invention.

FIG. 12 illustrates examples of VRTP protocol stacks according to the present invention.

FIG. 13 is a block diagram illustrating a client-pull speech recognition server system according to the present invention.

FIG. 14 is a block diagram illustrating a server push speech recognition server system according to the present invention

FIG. 15 is a schematic diagram of an embodiment of a client pull system according to the present invention.

FIG. 16 is a schematic diagram of an embodiment of a server push system according to the present invention.

FIG. 17 is a schematic diagram of another embodiment of a client pull system according to the present invention.

FIG. 18 is a schematic diagram of another embodiment of a client pull system according to the present invention

FIG. 19 shows the communication between the client and server for various protocols according to the present invention.

FIG. 20 illustrates an example of the present invention in operation for finding a stock price utilizing speech input.

### DETAILED DESCRIPTION OF THE INVENTION

The present invention recognizes individual words by comparison to parametric representations of predetermined words in a database. Those words may either be already stored in a speaker-independent speech recognition database or be created by adaptive sessions or training routines. A preferred embodiment of the present invention separates the microphone, front-end signal processing, and display at a mobile device, and the speech processors and databases at servers located at communications sites in a distributed speech recognition scheme, thereby achieving high speech recognition accuracy for small devices. In the preferred embodiment, the front-end signal processing performs feature extraction which reduces the required bit rate to be transmitted. Further, because of error correction performed by data transmission protocols, recognition performance is enhanced as opposed to conventional voice portals where recognition may suffer serious degradation over transmission (e.g., as in early-day long-distance calling). Thus, the present invention is advantageously applicable for the Internet or intranet systems. Other uses include electronic games and toys, entertainment appliances, and any computers or other electronic devices where voice input is useful.

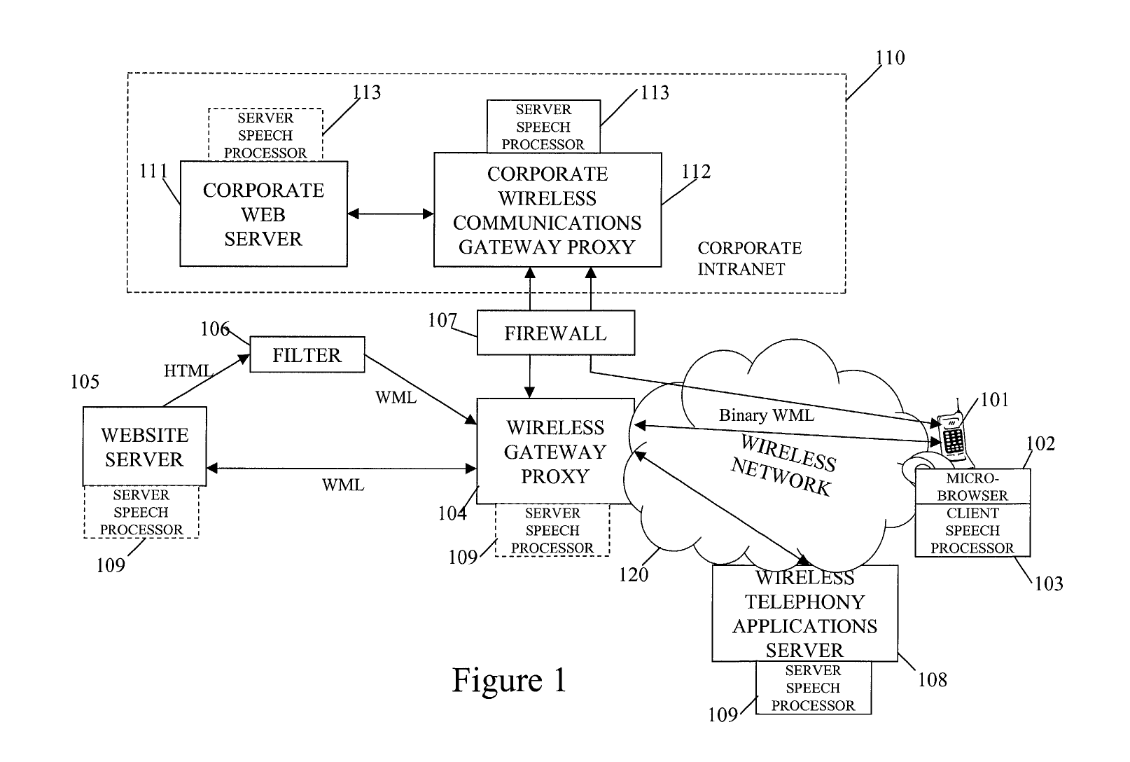

FIG. 1 illustrates the scheme of the present invention wherein a mobile communication device (an exemplary cell phone) 101 communicates with an exemplary website server 105 at some Internet website through a wireless gateway proxy server 104 via a wireless network 120. A wireless telephony applications server 108 provides call control and call handling applications for the wireless communications system. HTML from website server 105 must be filtered to WML by filter 106 for wireless gateway proxy server 104. To achieve speech query and/or command functionality for mobile Internet access, in a first embodiment of the present invention, a server speech processor 109 is disposed at wireless telephony applications (WTA) server 108. In a second embodiment, server speech processor 109 is disposed at wireless gateway proxy server 104. In a third embodiment, server speech processor 109 is disposed at web server 105. For communications with a corporate intranet 111, mobile device 101 (for example utilizing binary WML) must pass through a firewall 107 to access corporate wireless communications gateway proxy server 112. In one embodiment of the present invention, proxy server 112 includes a server speech processor 113. In another embodiment, server speech processor 113 resides in corporate web server 111.

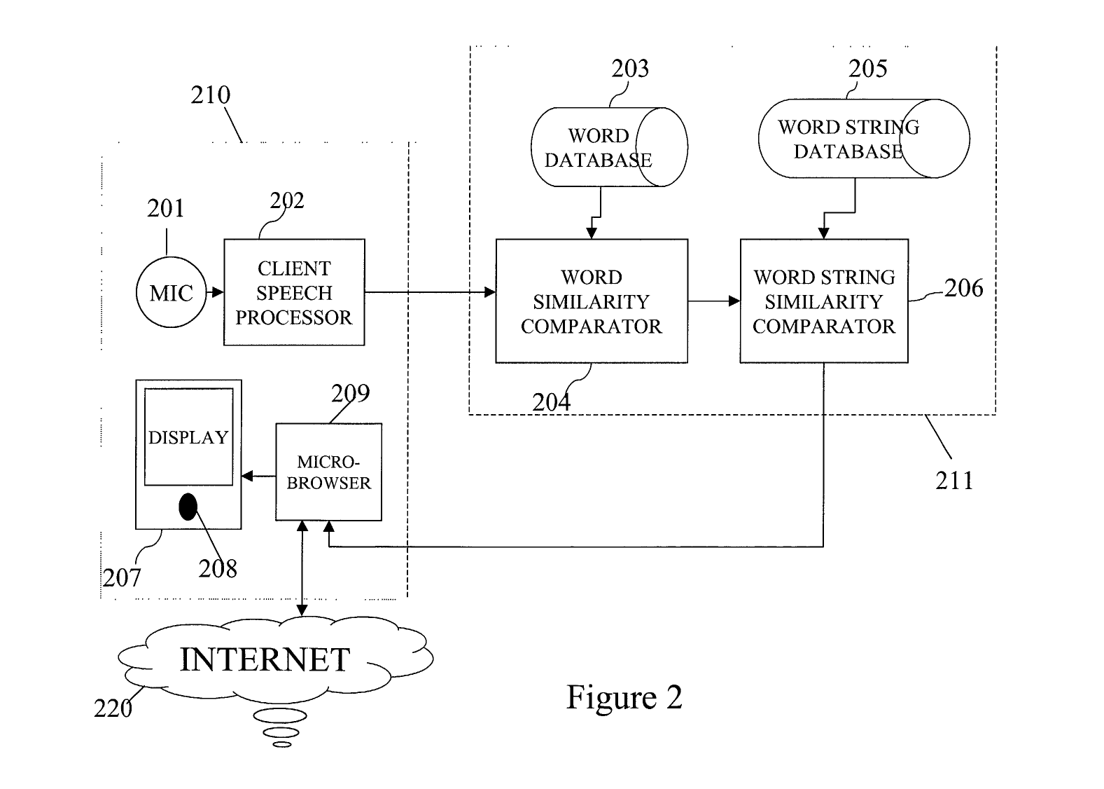

FIG. 2 is a block diagram illustrating the distributed automatic speech recognition system according to the present invention. A microphone 201 is coupled to a client speech processor 202 for digitally parameterizing an input speech signal. Word similarity comparator 204 is coupled (or includes) a word database 203 containing parametric representations of words which are to be compared with the input speech words. In the preferred embodiment of the present invention, words from word database 203 are selected and aggregated to form a waveform string of aggregated words. This waveform string is then transmitted to word string similarity comparator 206 which utilizes a word string database 205 to compare the aggregated waveform string with the word strings in word string database 205. The individual words can be, for example, “burger king” or “yuan dong bai huo” (“Far Eastern Department Store” in Chinese) which aggregate is pronounced the same as the individual words. Other examples include the individual words like “mi tsu bi shi” (Japanese “Mitsubishi”) and “sam sung” (Korean “Samsung”) which aggregate also is pronounced the same as the individual words. In the preferred embodiment, microphone 201 and client speech processor 202 are disposed together as 210 on, for example, a mobile phone (such as 101 in FIG. 1) which includes a display 207, a hot key 208, and a micro-browser 209 which is wirelessly communicable with the Internet 220 and/or a corporate intranet 111 as shown in FIG. 1. Hot key 208 initiates a voice session and speech is then inputted through microphone 201 to be initially processed by client speech processor 201. It is understood that a menu point (“soft key”) in display 207 is equivalent to hot key 208. Word database 203, word similarity comparator 204, word string database 205, and word string similarity comparator 206 constitute server speech processor 211 which are shown as 109 or 113 in FIG. 1. In this way, the present invention provides greater storage and computational capability through the server 211, which allows more accurate, speaker-independent, and broader range speech recognition. The present invention also contemplates pre-stored parametric word databases consisting of specialized words for specific areas of endeavor (commercial, business, service industry, technology, academic, and all professions such as legal, medical, accounting, and so on) as particularly useful in corporate intranets. Typical words and abbreviations used in email or chat room communications (such “BTW”) can also be stored in the databases 203 and 205. Through comparison of the prerecorded waveforms in word database 203 with the input speech waveforms, a sequential set of phonemes is generated that are likely matches to the spoken input. A “score” value is assigned based upon the closeness of each word in word database 203 to the input speech. The “closeness” index is based upon a calculated distortion between the input waveform and the stored word waveforms, thereby generating “distortion scores”. If the scores are based on specialized word dictionaries, they are relatively more accurate. The words can be polysyllabic and can be terms or phrases as they will be further recognized by matches with word string database 205. That is, a phrase such as “Dallas Cowboys” or “Italian restaurants” can be recognized a aggregated word strings more accurately than the individual words (or syllables). Complete sentences, such as “Where is the nearest McDonald's?” can be recognized using aggregated word strings according to the present invention.

In the preferred embodiment of the invention, client speech processor 202 utilizes linear predictive coding (LPC) for speech feature extraction. LPC offers a computationally efficient representation that takes into consideration vocal tract characteristics (thereby allowing personalized pronunciations to be achieved with minimal processing and storage).

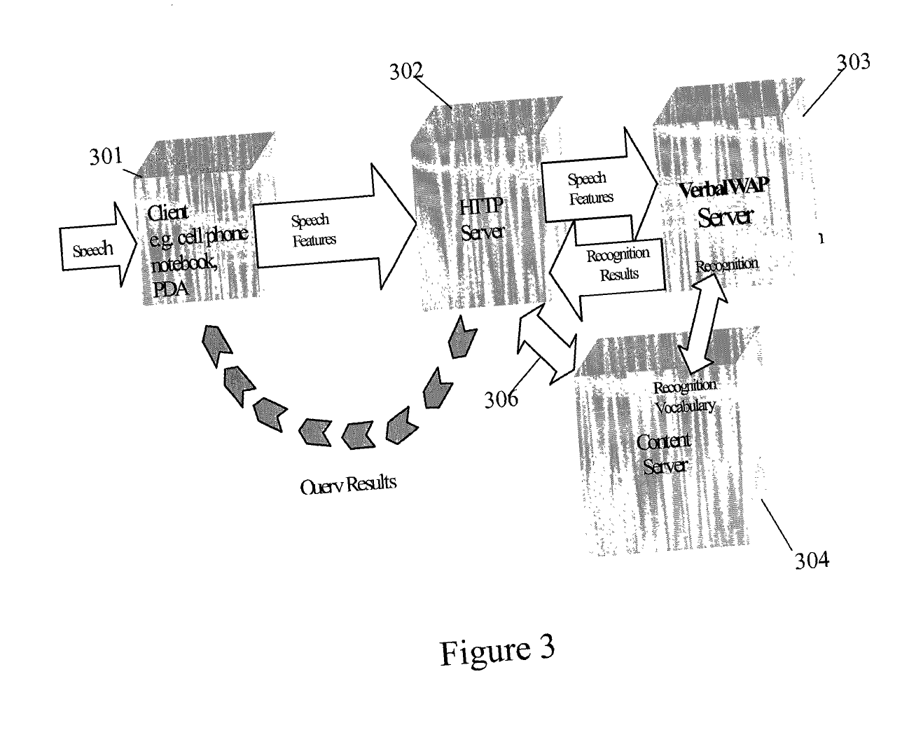

FIG. 3 is a block diagram of an embodiment of the present invention as implemented for Internet/Intranet speech recognition communication. In this and the following figures, the block labels are specific for exemplary illustration ease of understanding; it being understood that any communications network transport protocol is within the contemplation of the present invention, not only the HTTP and WAP as labeled for instance. In operation, speech, for example a query, is entered through a client (cell phone, notebook computer, PDA, etc.) 301 where the speech features are extracted and transmitted in packets over an error-protected data channel to HTTP server 302. Recognition according to the present invention is performed at VerbalWAP server 303 in conjunction with content server 304 which, in one embodiment, includes a specialized recognition vocabulary database. The results of the recognition are transferred back to server 303 and passed to HTTP server 302 which provides the query results to client 301. If the initial query is non-vocal, then server 303 is not invoked and the information is transferred traditionally through channel 306.

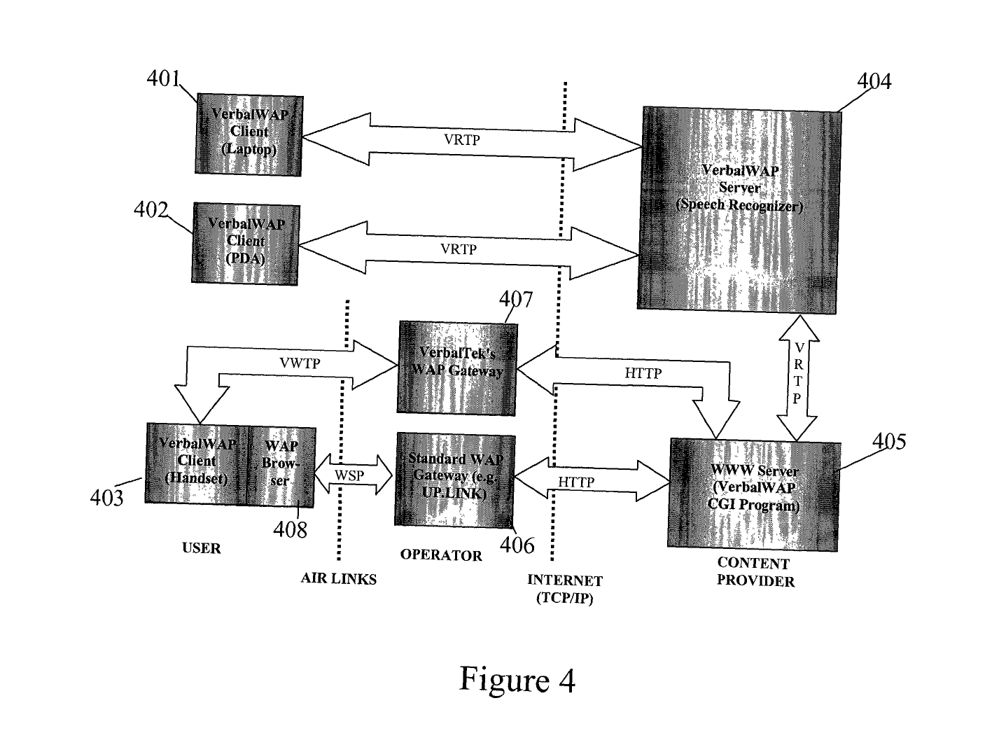

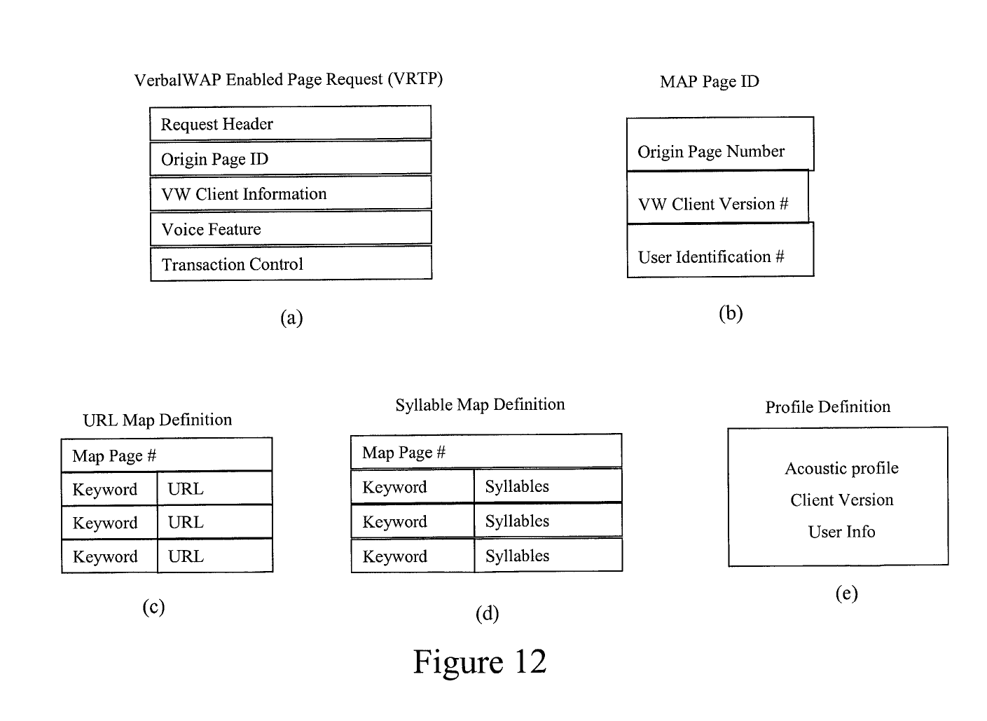

FIG. 4 is a block diagram showing the communications protocol according to the present invention. Clients laptop computer 401, PDA 402 and handset 403 are the users. Laptop 401 and PDA 402 communicate with VerbalWAP server 404 utilizing a voice recognition transaction protocol (VRTP, based on TCP/IP) according to the present invention. Server 404 communicates with a WWW server 405 which is a content provider and implements a VerbalWAP Cell Global Identity (CGI) program according to the present invention. Utilizing VRTP, server 405 communicates through server 404 to clients 401 and 402. For cell phone handsets 403, there are two modes of communication possible: In the standard WAP gateway mode, the speech features are transmitted from handset client 403 utilizing the standard WAP protocol stack (Wireless Session Protocol WSP) via a WAP browser 408 to a standard WAP gateway 406 (for example, UP.LINK) and thence via HTTP to content provider 405 having a CGI program (for example, a VerbalWAP CGI). The CGI program opens a VRTP socket to transmit the speech features to content provider server 405 which in turn transmits via VRTP to a local VerbalWAP server 404 which provides speech recognition. VerbalWAP CGI then dynamically generates a WML page responsive to that recognition and the page is transmitted back to client handset 403 via standard WAP gateway 406. In the VerbalTek WAP gateway mode, a dedicated socket for the Verbal WAP Transaction Protocol (VWTP) talks directly with WAP gateway 407 which communicates with content provider server 405 through HTTP. WAP browser 408 is used only for displaying the return page. Descriptions of the various protocol stacks in VRTP are provided below with reference to FIG. 12.

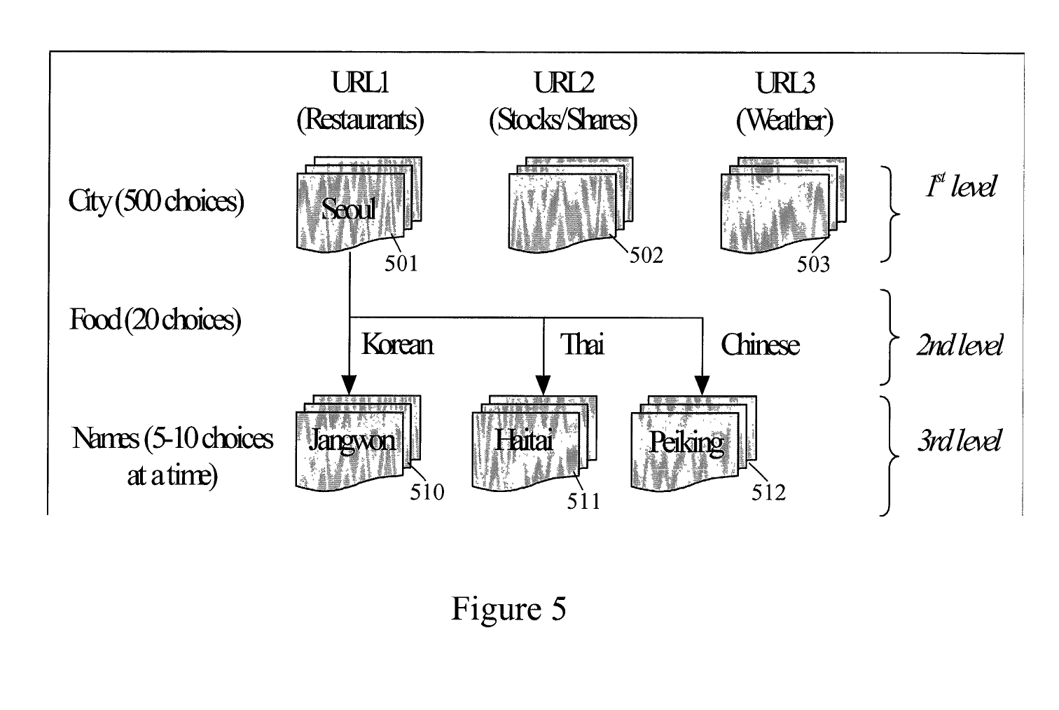

FIG. 5 shows an example of a data structure in content provider server 405. A client in an unfamiliar location, for example Seoul, South Korea, want to find a restaurant. By saying “restaurants” the URL 1 for restaurants is accessed. When prompted for the city, the client states “Seoul” for the data base at the 1^{st} level of the database. When prompted for the type of food, the client states “Korean” at the 2^{nd} level. A list of Korean restaurants is then returned at the 3^{rd} level, from which the client may choose “Jangwon” and the details of that restaurant will be displayed, for example, specials, prices, etc.

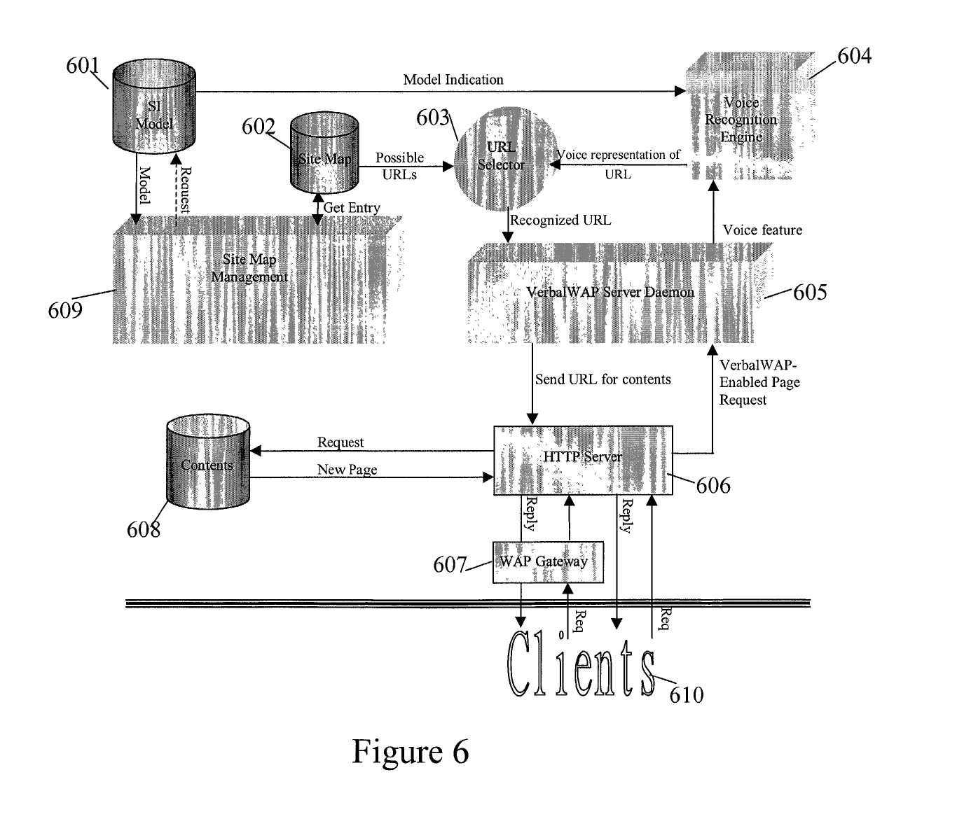

FIG. 6 is a block diagram of an embodiment of the present invention for a speech recognition server architecture implemented on the Internet utilizing wireless application protocol (WAP). It is understood that this and the following descriptions are made with reference to the Internet and WAP but that the implementation of the server system of the present invention on any communications network is contemplated and that the diagrams and descriptions are exemplary of a preferred embodiment only. Site map 602 maintains a URL table of possible website choices denoted in a query page. As an example, a WAP handset client 610 issues a request through a WAP gateway 607 to HTTP server 606. Requests from laptops or PDA clients 610 are sent directly to HTTP server 606. Speech requests are transmitted to VerbalWAP server daemon 605 via a VerbalWAP enabled page request (indicating a speech to be recognized). The speech feature is transmitted to voice recognition engine 604. Voice recognition of all the possible URLs in site map 602 are obtained through site map management 609 by reference to the speaker model, in this example, a speaker independent (SI) model 601. In other embodiments of the present invention, the speaker model is speaker dependent (requiring enrollment or training) and/or speaker adaptive (learning acoustic elements of the speaker's voice), respectively. As known in the art, the speaker dependent and speaker adaptive models generally provide greater speech recognition accuracy than speaker independent models. The possible URLs from site map 602 are transmitted to URL selector 603 for final selection to match the voice representation of the URL from voice recognition engine 604. URL selector 603 then sends the recognized URL to VerbalWAP server daemon 605 which in turn transmits the URL to HTTP server 606 which initiates a request from contents provider 608 which sends a new page via HTTP server 606 to clients 610 either through WAP gateway 607 (for mobile phones) or directly (for laptops and PDAs). HTTP server 606 includes components known in the art, such as additional proxy servers, routers, and firewalls.

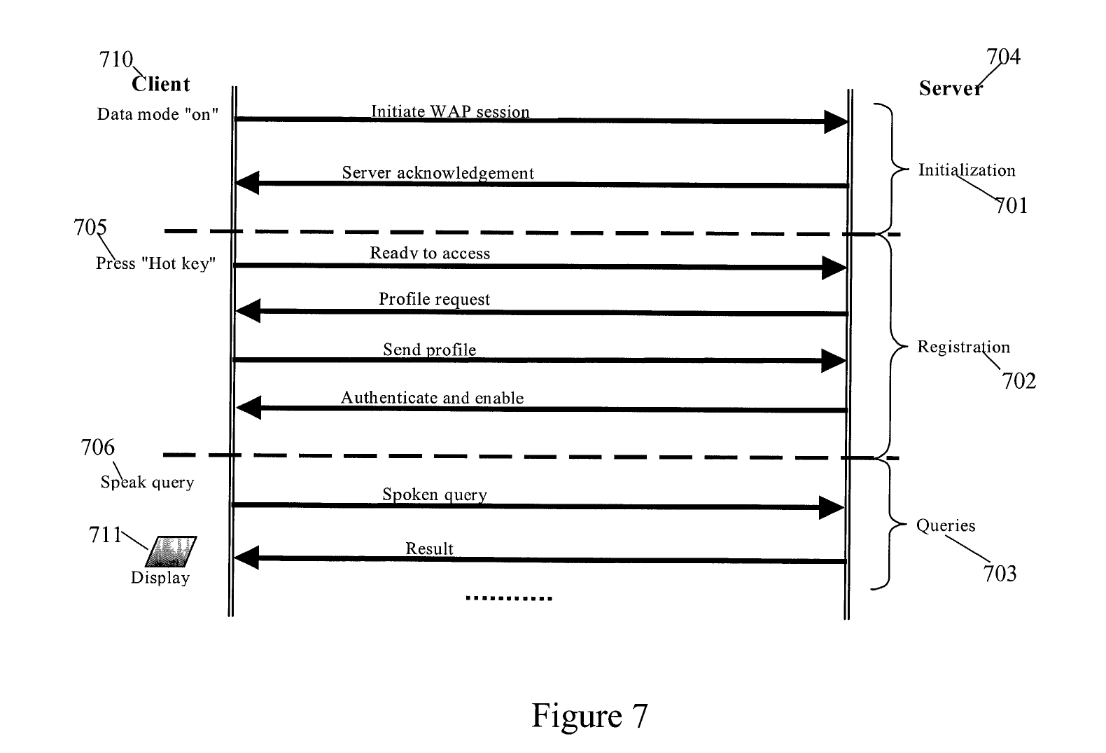

FIG. 7 is a diagram illustrating a client-server communications scheme according to the present invention. A WAP session includes three sections: initialization, registration and queries. At initialization 701, a client 710 (handset, laptop, PDA, etc.) indicates the data mode is “on” by, for instance, turning on the device with speech recognition enabled. The server 704 sends an acknowledgement including “VerbalWAP-enabled server” information. At registration 702, when hot key 705 (or an equivalent menu point soft key) is pressed, a client profile request is sent by server 704 for user authentication and specific user enablement of speech recognition. If there is no existing profile (first-time user), client 710 must create such. At query 703, hot key 705 must be again pressed (and in this embodiment, it must be pressed for each query) and the query is processed according to the scheme illustrated in FIG. 6 and its accompanying description above.

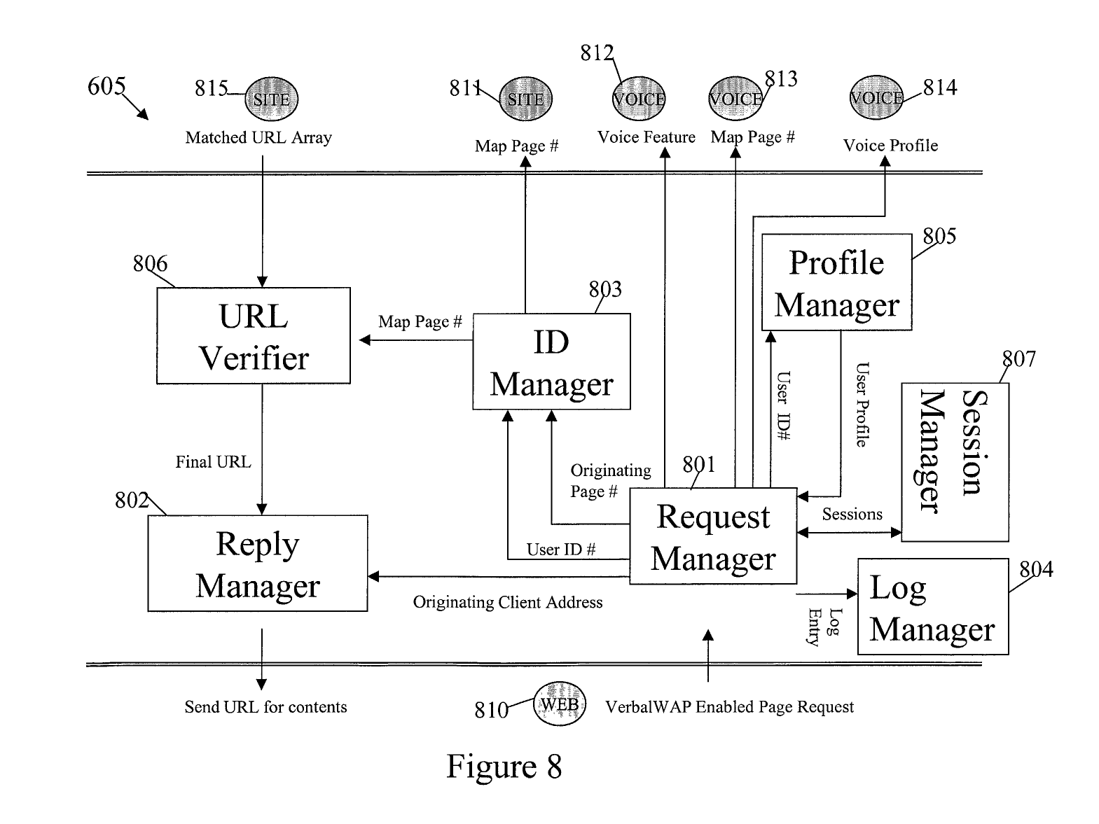

In one embodiment of the present invention, voice bookmarking allows a user to go directly to a URL without going through the hierarchical structure described above. For example, for a stock value, the user need only state the name of the stock and the system will go directly the URL where that information is given. Also, substituted values can be performed; for example, by saying the name of a restaurant, the system will dial the telephone number of that restaurant. The methods for achieving bookmarking are known in the art (for example, Microsoft's “My Favorites”). FIG. 8 is a schematic diagram of VerbalWAP server daemon 605 architecture. The essential components of server daemon 605 are a request manager 801, a reply manager 802, an ID manager 803, a log manager 804, a profile manager 805, a URL verifier 806, and a sessions manager 807. Request manager 801 receives a voice payload from clients through HTTP server 606 (FIG. 6) shown as web 810 in the form of a VerbalWAP enabled page request. The user ID is passed to profile manager 805. If the client is a first-time user, profile manager 805 requests voice recognition engine 604 (FIG. 6) to create a voice profile. Request manager 801 transmits a request for log entry to log manager 804 which does the entry bookkeeping. Request manager 801 also transmits a request for an ID to ID manager 803 which generates a Map ID for the client. Now having the essential user data profile, request manager 801 passes the ID, current voice feature, and user's voice profile to voice recognition engine 604 (FIG. 6) shown as voice feature 812, voice map page number 813, and voice profile 814. Request manager 801 also sends and originating page number and user ID number to ID manager 803 which in turn transmits a map page number to sitemap management 609 (FIG. 6) shown as site 811. Site map management 609 (FIG. 6) receives the query information and returns matched URLs to URL verifier 806 in the manner shown in FIG. 6 and described above and shown as site 811 and site 815. URL verifier 806 performs the final check on the recognized URL and transmits the result to reply manager 802 which requests HTTP server 606 to fetch the contents of the recognized contents server 608 (FIG. 6). That contents is then sent to the client utilizing the originating client address provided by request manager 801. Session manager 807 records each activity and controls the sequence of actions for each session.

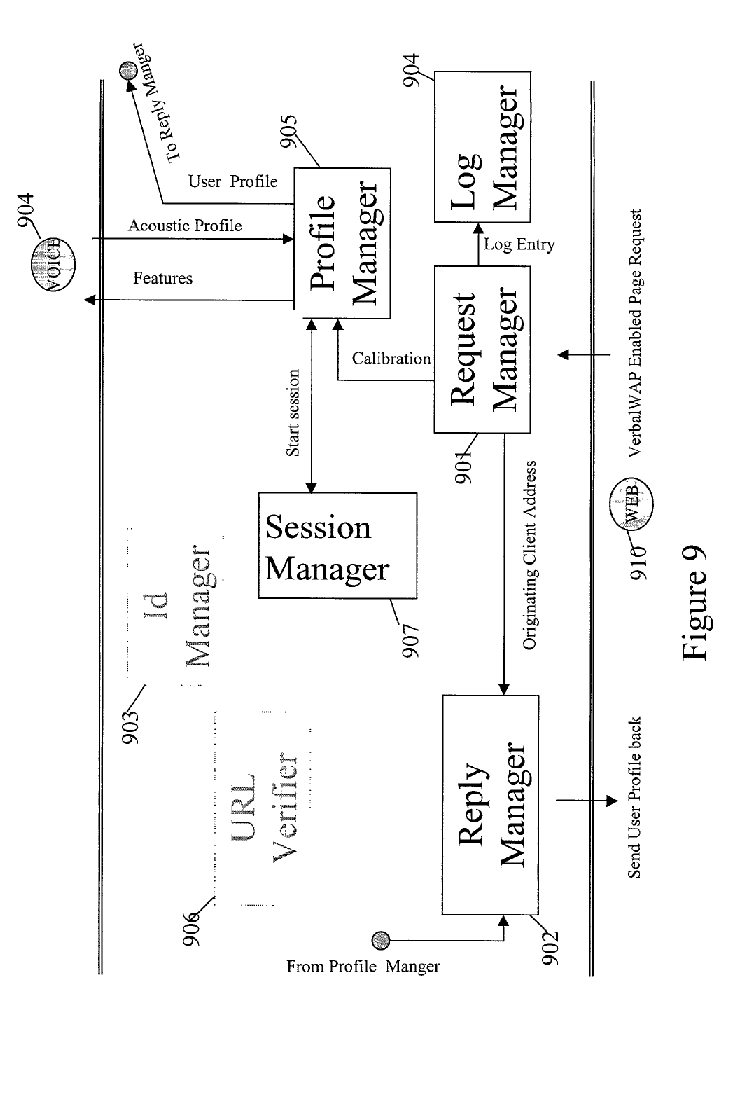

FIG. 9 is a schematic diagram illustrating a supervised adaptation session implemented by the server daemon 605 according to the present invention. Request manager 901 receives a voice request through HTTP server 606 (FIG. 6), shown as Web 910, and transmits a log entry to log manager 904. As described above for log manager 804, log manager 904 does the bookkeeping. Profile manager 905 requests voice recognition engine 604 (FIG. 6), shown as Voice 904, to generate an acoustic profile. This acoustic profile is the speaker adaptation step in the voice recognition of the present invention. Speaker adaptation methods are known in the art and any such method can be advantageously utilized by the present invention. Voice 904 returns the acoustic profile to profile manager 905 which then includes it in a full user profile which it creates and then transmits to reply manager 902. Reply manager 902 then requests Web 910 to transmit the user profile back to the client for storage.

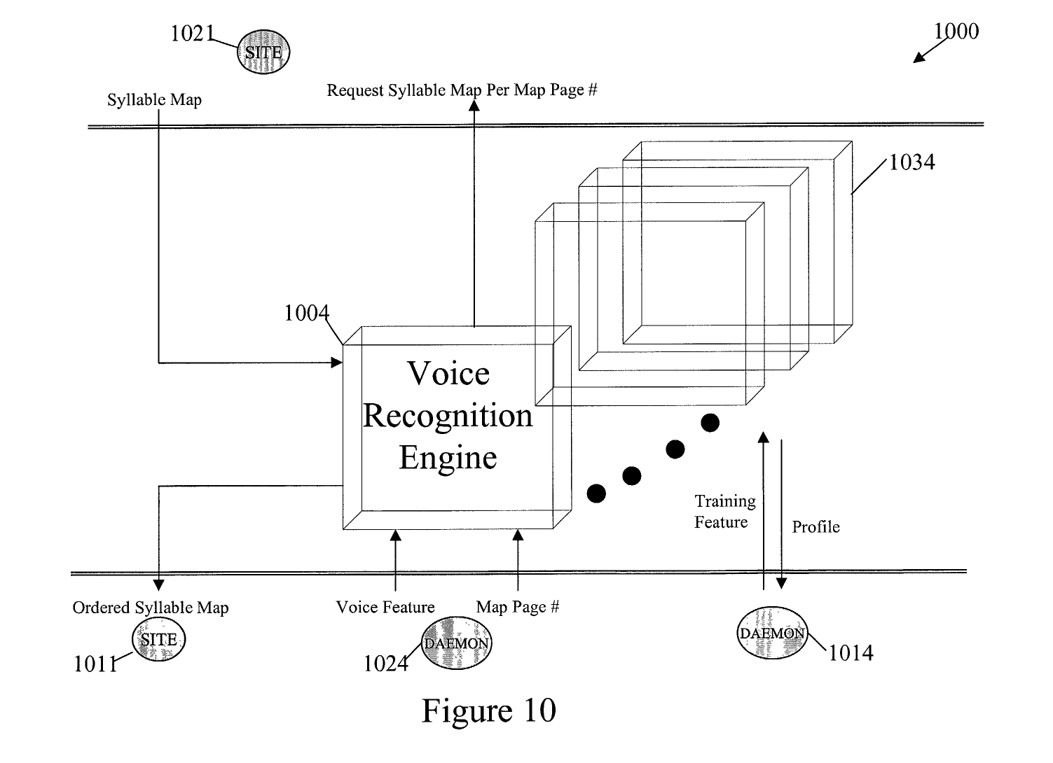

FIG. 10 is a schematic representation of a voice recognition server 1000 including a voice recognition engine 1004. The present invention includes a plurality of voice recognition engines (collectively designated 1034) depending on what language is used, what is the client (cell phone, computer, PDA, etc.), and whether it is a speaker-independent, adaptive, or training program. VerbalTek, the assignee of the present invention, sells a number of different language programs, including particularly Korean, Japanese, and Chinese, which are speaker-independent, adaptive, or trained. The version of voice recognition engine 1034 depends on the version designated in the client, which version identification is embedded in the ID number passed from daemon 1024. As described above, the voice feature is transmitted from daemon 1024 to voice recognition engine 1004, 1034 together with a map page number. Sitemap management 609 (FIG. 6), shown as 1021, transmits a syllable map depending on the map page number. The syllable map is matched against the incoming voice feature for recognition and an ordered syllable map is generated with the best syllable match scores. It is noted that the present invention utilizes programs developed by VerbalTek, the assignee of the present invention, that are particularly accurate for aggregated syllable/symbol languages such as Korean, Japanese, and Chinese. The ordered syllable map is then passed to URL selector 603 (FIG. 6).

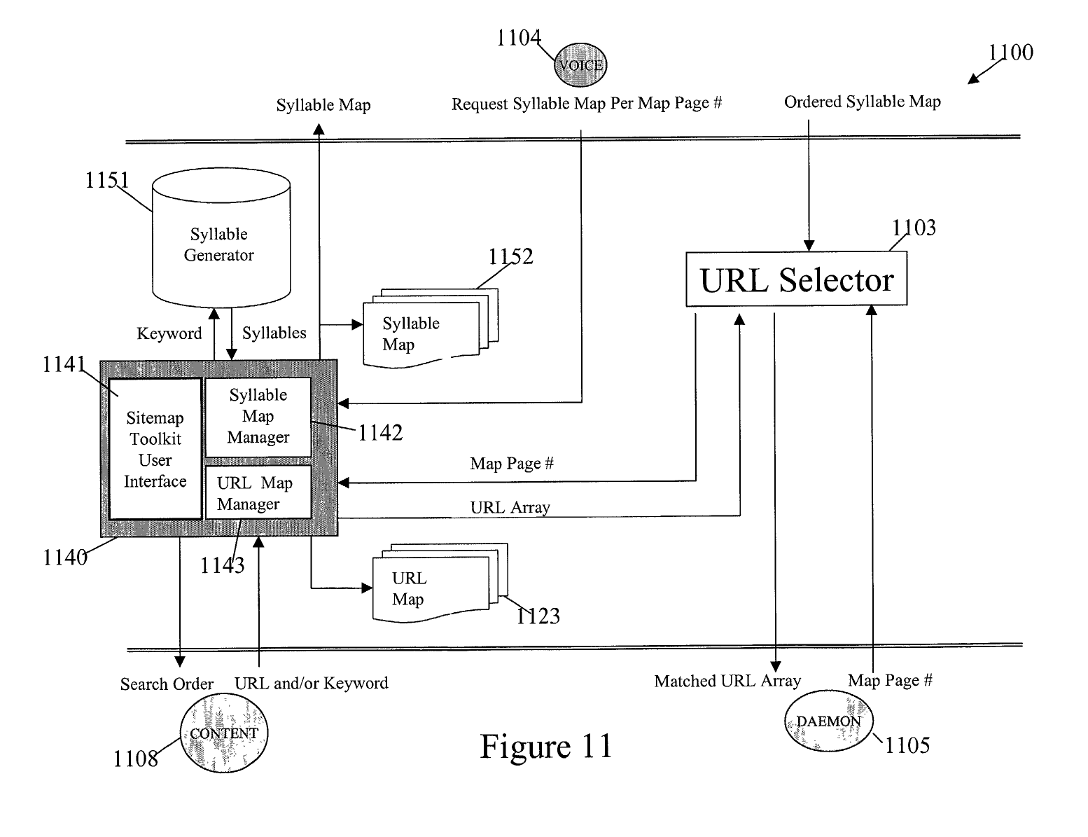

FIG. 11 is a schematic diagram of a sitemap management 1100 architecture according to the present invention. The principal components are URL selector 1103 (corresponding to 603 of FIG. 6), a syllable generator 1151, a sitemap toolkit 1140 including a user interface 1141, a syllable map manager 1142, and a URL map manager 1143. The words for voice queries and other voice information are stored in syllable map 1152 and URL map 1123. In one embodiment of the present invention, the data in syllable map 1152 and URL map 1123 are created by the user. In another embodiment, that data is pre-stored, the contents of the data being dependent on the language, types of services, etc. In another embodiment, the data is created in run-time as requests come in. Voice recognition engine 604 (FIG. 6), shown as voice 1104, accesses syllable map manager 1142 in sitemap toolkit 1140 which passes the user-provided keyword to syllable generator 1151. Syllables are matched with keywords and stored in syllable map 1152.

FIG. 12 illustrates examples of the essential elements of VRTP protocol stacks for the functions shown in FIGS. 6 and 8-11. FIG. 12(a) lists the essential elements of the VerbalWAP Enabled Page Request shown in FIG. 6 (between HTTP server 606 and VerbalWAP server daemon 605), FIG. 8 (at web 810), and FIG. 9 (at web 910). FIG. 12(b) shows the essential elements of the MAP Page ID shown in FIG. 8 (between ID manager 803 and URL verifier 806 and site 811), FIG. 10 (from daemon 1024) and FIG. 12 (from daemon 1105 and between URL selector 1103 and sitemap toolkit 1140). FIG. 12(c) shows the essential elements of the URL Map Definition (shown in FIG. 11 at URL map 1123). FIG. 12(d) shows the essential elements of the Syllable Map Definition (shown in FIG. 11 at syllable map 1152). FIG. 12(e) shows the essential elements of the Profile Definition (shown in FIG. 8 between request manager 801 and voice 814 and profile manager 805, FIG. 9 between profile manager 905 and reply manager 902 and voice 904, and FIG. 10 between voice recognition engine 1034 and daemon 1014). It is understood that the protocol stacks illustrated represent embodiments of the present invention whose transaction protocols are not limited to these examples.

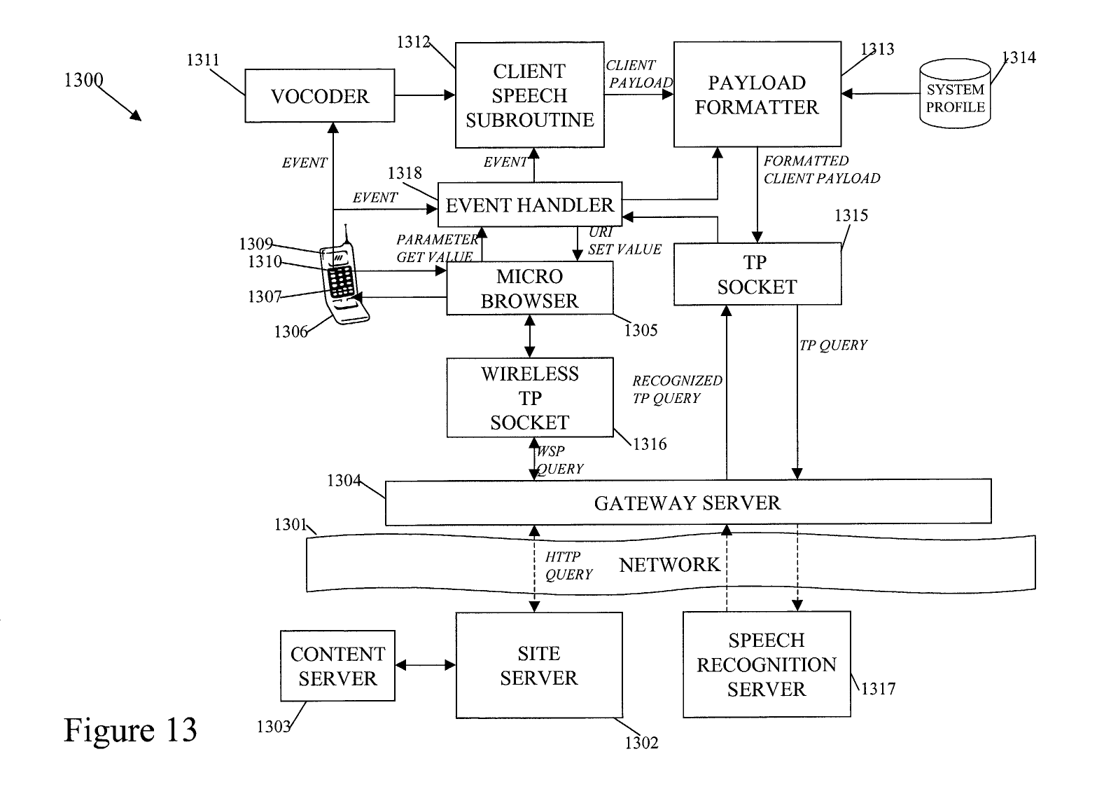

FIG. 13 is a block diagram illustrating a client-pull speech recognition system 1300 according to the present invention for implementation in a communications network having a site server 1302, a gateway server 1304, a content server 1303, and a plurality of clients 1306 each having a keypad 1307, a display 1309, and a micro-browser 1305. A hotkey 1310, disposed on keypad 1307, initializes a voice session. A vocoder 1311 generates the voice data frames from the input speech in digitized voice signal form for transmission to a client speech subroutine 1312 which performs speech feature extraction and generates a client payload. A system-specific profile database 1314 stores and transmits system-specific client profiles, such as system host information, client type, and the user acoustic profile, to a payload formatter 1313 which formats the client payload data flow received from the client speech subroutine 1312 with data received from system-specific profile database 1314. A speech recognition server 1317 is communicable with gateway server 1304 and performs speech recognition of the formatted client payload. A transaction protocol (TP) socket 1315, communicable with payload formatter 1313 and gateway server 1304, receives the formatted client payload from payload formatter 1313, converts the client payload to a wireless speech TP query, and transmits the wireless speech TP query via gateway server 1304 through communications network 1301 to speech recognition server 1317, and further receives a recognized wireless speech TP query from speech recognition server 1317, converts the recognized wireless speech TP query to a resource identifier (e.g., URI), and transmits the resource identifier to micro-browser 1305 for identifying the resource responsive to the resource identifier. A wireless transaction protocol socket 1316, communicable with micro-browser 1305 and gateway server 1304, receives the resource query from micro-browser 1305 and generates a wireless session (e.g., WSP) via gateway server 1304, which converts the WSP to HTTP, and through communications network 1301 to site server 1302 and thence to content server 1303, and further receives content from content server 1303 and transmits the content via site server 1302, network 1300, and gateway server 1304 to client 1306 to be displayed on display 1309. An event handler 1318, communicable with hotkey 1310, client speech subroutine 1312, micro-browser 1306, TP socket 1315, and payload formatter 1313, transmits event command signals and synchronizes the voice session among those devices.

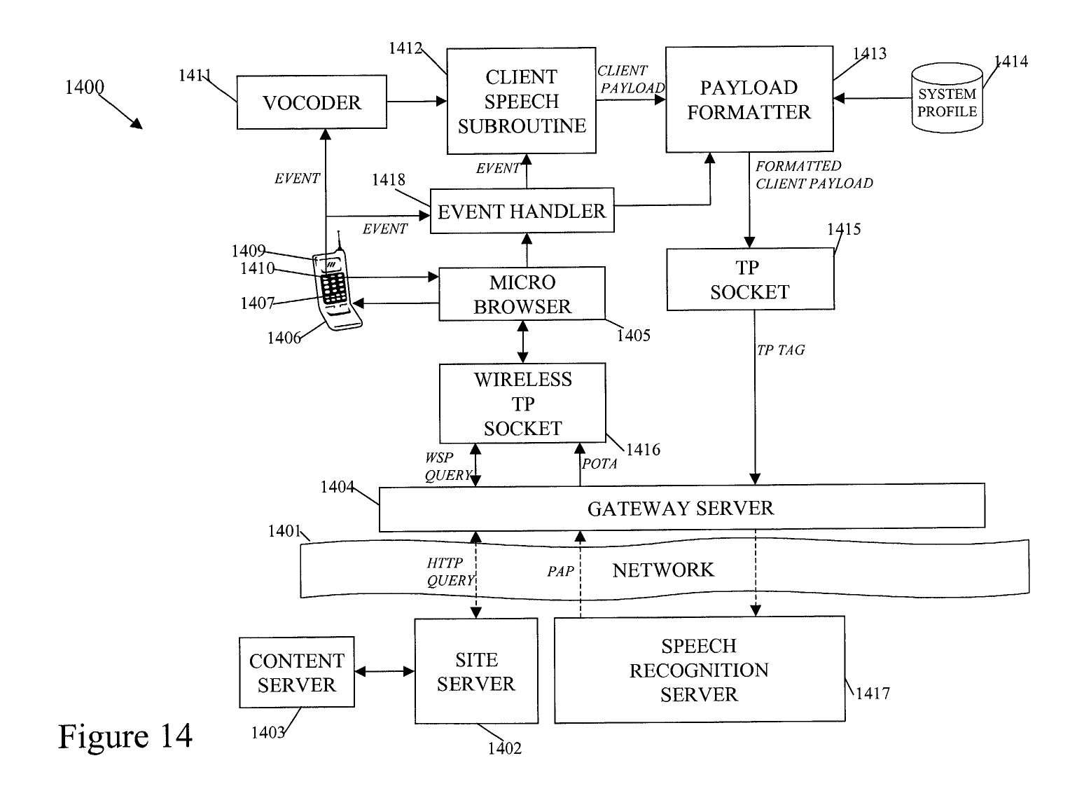

FIG. 14 is a block diagram illustrating a server-push speech recognition server system 1400 according to the present invention for implementation in a communications network having a server 1402, a gateway server 1404, a contents server 1403, and a plurality of clients 1406 each having a keypad 1407, a display 1409, and a micro-browser 1405. A hotkey 1410, disposed on keypad 1407, initializes a voice session. A vocoder 1411 generates the voice data frames from the input speech in digitized voice signal form for transmission to a client speech subroutine 1412 which performs speech feature extraction and generates a client payload. A system-specific profile database 1414 stores and transmits system-specific client profiles, such as system host information, client type, and the user acoustic profile, to a payload formatter 1413 which formats the client payload data flow received from the client speech subroutine 1412 with data received from system-specific profile database 1414. A speech recognition server 1417 is communicable with gateway server 1404 and performs speech recognition. A transaction protocol (TP) socket 1415, communicable with payload formatter 1413 and gateway server 1404, receives the formatted client payload from payload formatter 1413, converts the client payload to a transport protocol (TP) tag, and transmits the TP tag via gateway server 1404 through communications network 1401 to speech recognition server 1417. A wireless transaction protocol socket 1416, communicable with micro-browser 1405 and gateway server 1404, receives a wireless push transmission from gateway server 1404 responsive to a push access protocol (PAP) transmission from speech recognition server 1417, and receives a resource transmission from micro-browser 1405 and transmits the resource transmission via gateway server 1404 through communications network 1401 to contents server 1403, and further receives content from content server 1403 and transmits same to client 1406 for display on display 1409. An event handler 1418, communicable with hotkey 1410, client speech subroutine 1412, micro-browser 1405, and payload formatter 1413, synchronizes the voice session among those devices.

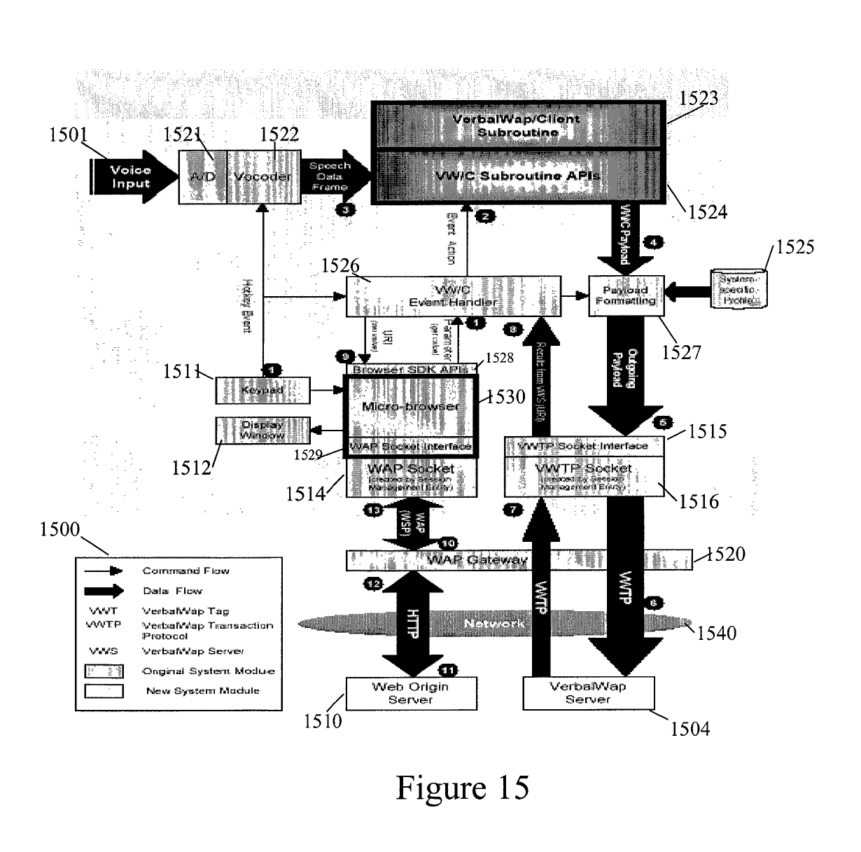

FIG. 15 is a schematic diagram of an embodiment of a client pull system according to the present invention where the command and data flows are depicted as arrows and modules as rectangles (as summarized in box 1500) and the sequence of events is given by encircled numerals 1 to 13. User depresses a hot key on keypad 1511 and a Hot Key Event signal (1) is sent to vocoder 1522 and VW/C event handler 1526. Keypad 1511 also sends a signal to micro-browser 1530 which, through browser SDK APIs 1528 sends a get value parameter (1) to VW/C event handler 1526. Then VW/C event handler 1526 sends an event action signal (2) to VW/C subroutine APIs 1524. User then voice inputs at 1501 to an analog to digital (A/D) converter 1521 and vocoder 1522 generates speech data frame(s) (3) to be input to VW/C subroutine API 1524 which has a VerbalWAP/Client subroutine overlay 1523. A VW/C payload (4) is transmitted to payload formatter 1527 which receives system specific profile data from database 1525 and a signal from VW/C event handler 1526 responsive to the Hotkey Event signal. Payload formatter sends an outgoing payload (5) via VWTP (VerbalWap Transaction Protocol) socket interface 1515 to VWTP socket 1516. The VWTP data flow (6) is sent to VerbalWap server 1504 via network 1540 which may be any communications network. VerbalWap server 1504 processes the speech data as described above and utilizes VWTP to send the speech processing results and other information back to VWTP socket 1516 (7). Via VWTP socket interface 1515, the results from VerbalWap server 1504 (including the uniform resource identifier URI) are transmitted to VW/C event handler 1526 (8) which transmits a URI set value command (9) to micro-browser 1530 through browser SDK APIs 1528. Micro-browser 1530 then sends a display content to display window 1512 and a WAP WSP signal (10) to WAP gateway 1520 which converts and sends a HTTP message (11) to Web origin server 1510 for content. Web origin server 1510 sends a return HTTP message (12) which is filtered back to WAP WSP by WAP gateway 1520 (13) and sent through WAP socket 1514, WAP socket interface 1529 to micro-browser 1530 which sends the results to display window 1512.

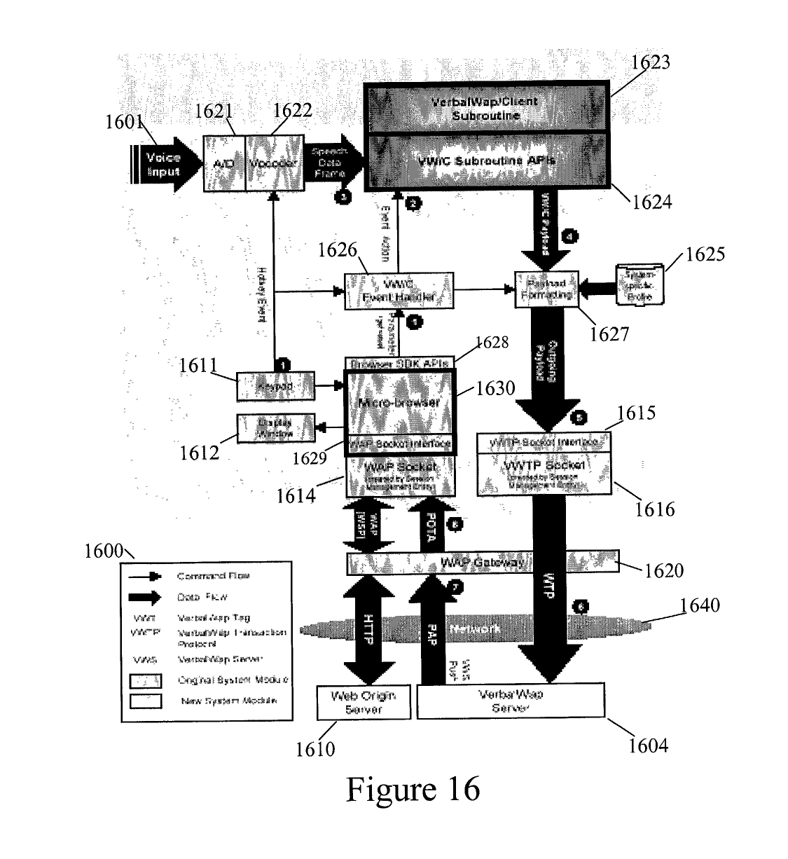

FIG. 16 is a schematic diagram of an embodiment of a server push system according to the present invention where the command and data flows are depicted as arrows and modules as rectangles (as summarized in box 1600) and the sequence of events is given by encircled numerals 1 to 8. User depresses a hot key on keypad 1611 and a Hot Key Event signal (1) is sent to vocoder 1622 and VW/C event handler 1626. Keypad 1611 also sends a signal to micro-browser 1630 which, through browser SDK APIs 1628 sends a get value parameter (1) to VW/C event handler 1626. Then VW/C event handler 1626 sends an event action signal (2) to VW/C subroutine APIs 1624. User then voice inputs at 1601 to an analog to digital (A/D) converter 1621 and vocoder 1622 generates speech data frame(s) (3) to be input to VW/C subroutine API 1624 which has a VerbalWAP/Client subroutine overlay 1623. A VW/C payload (4) is transmitted to payload formatter 1627 which receives system specific profile data from database 1625 and a signal from VW/C event handler 1626 responsive to the Hotkey Event signal. Payload formatter sends an outgoing payload (5) via VWTP socket interface 1615 to VWTP socket 1616. The VWTP data flow (6) is sent to VerbalWap server 1604 via network 1640 which may be any communications network. VerbalWap server 1604 processes the speech data as described above and performs a VWS push utilizing PAP (Push Access Protocol) (7) via network 1640 through WAP gateway 1620 utilizing push over the air (POTA) to WAP socket 1614 which returns a WAP WSP data flow through WAP gateway 1620 which converts to HTTP and is transmitted through network 1640 to web origin server 1610. Web origin server 1610 provides content which it transmits back through network 1640 using HTTP to WAP gateway 1620 which filters HTTP to WAP WSP and through WAP socket 1614 interface 1629 to micro-browser 1630 which provides a display content to display window 1612.

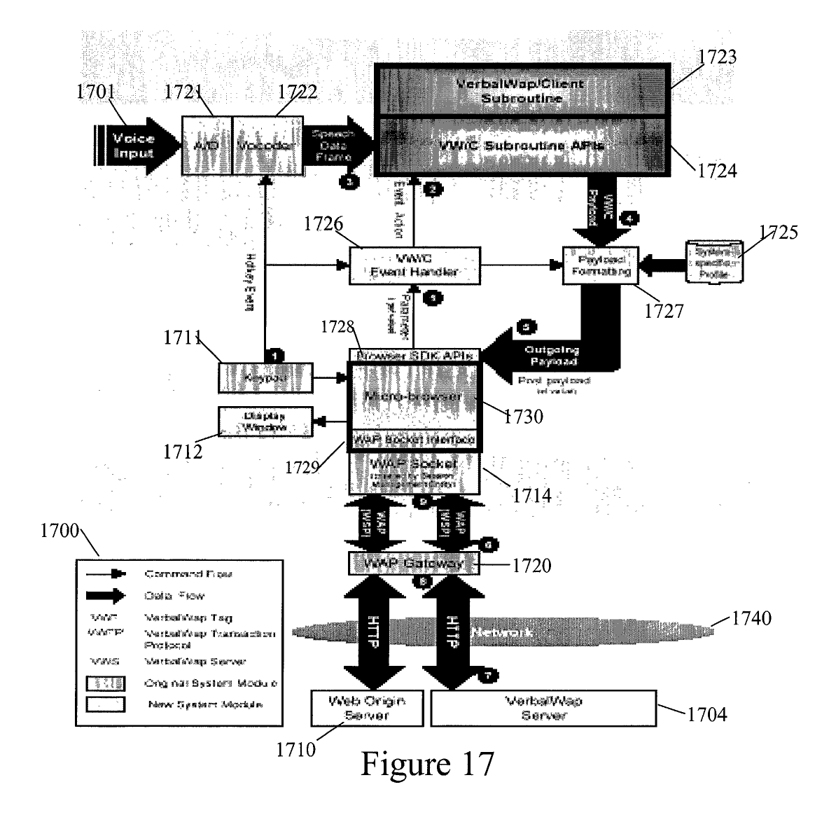

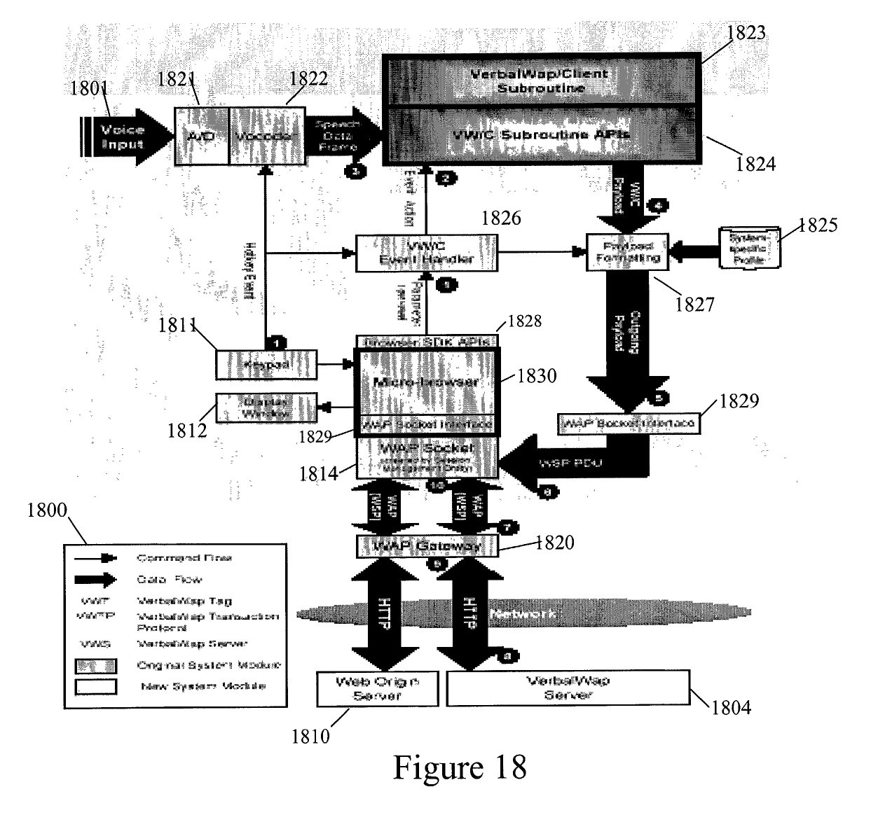

FIG. 17 is a schematic diagram of another embodiment of a client pull system according to the present invention where the command and data flows are depicted as arrows and modules as rectangles (as summarized in box 1700) and the sequence of events is given by encircled numerals 1 to 8. User depresses a hot key on keypad 1711 and a Hot Key Event signal (1) is sent to vocoder 1722 and VW/C event handler 1726. Keypad 1711 also sends a signal to micro-browser 1730 which, through browser SDK APIs 1728 sends a get value parameter (1) to VW/C event handler 1726. Then VW/C event handler 1726 sends an event action signal (2) to VW/C subroutine APIs 1724. User then voice inputs at 1701 to an analog to digital (A/D) converter 1721 and vocoder 1722 generates speech data frame(s) (3) to be input to VW/C subroutine API 1724 which has a VerbalWAP/Client subroutine overlay 1723. A VW/C payload (4) is transmitted to payload formatter 1727 which receives system specific profile data from database 1725 and a signal from VW/C event handler 1726 responsive to the Hotkey Event signal. Payload formatter sends an outgoing payload (5) via VWTP socket interface 1717 to browser SDK API 1728 for micro-browser 1730. After passing through WAP socket interface 1729 and WAP socket 1714, a WAP WSP (6) is passed to WAP gateway 1720 which translates to HTTP and then to VerbalWap server 1704 via network 1740 which may be any communications network. VerbalWap server 1704 processes the speech data as described above and utilizes HTTP to send the speech processing results and other information back through WAP gateway 1720 (8) to WAP socket 1714. Micro-browser 1730 finds the site and send the information back via WAP WSP to WAP gateway 1720, via HTTP to web origin server 1710 where content is provided in HTTP and transmitted and filtered to WAP WSP for WAP socket 1714 and then by WAP WSP to micro-browser 1730 to displayed at display window 1701. FIG. 18 is a schematic diagram of another embodiment of a client pull system according to the present invention where the command and data flows are depicted as arrows and modules as rectangles (as summarized in box 1800) and the sequence of events is given by encircled numerals 1 to 8. This embodiment is the same as that shown in FIG. 17 except that the outgoing payload at (5) is sent to WAP socket interface 1829 and a WSP PDU data flow is transmitted (8) to WAP socket 1814. Thereafter, the scheme is the same as that described above and shown in FIG. 17.

The present invention provides inexpensive scalability because it does not require an increase in dedicated lines for increased service. For example, a Pentium™ IV 1.4 GHz server utilizing the system of the present invention can service up to 10,000 sessions simultaneously.

As Web content increases, information such as weather, stock quotes, banking services, financial services, e-commerce/business, navigation aids, retail store information (location, sales, etc.), restaurant information, transportation (bus, train, plane schedules, etc.), foreign exchange rates, entertainment information (movies, shows, concerts, etc.), and myriad other information will be available. The Internet Service Providers and the Internet Content Providers will provide the communication links and the content respectively.

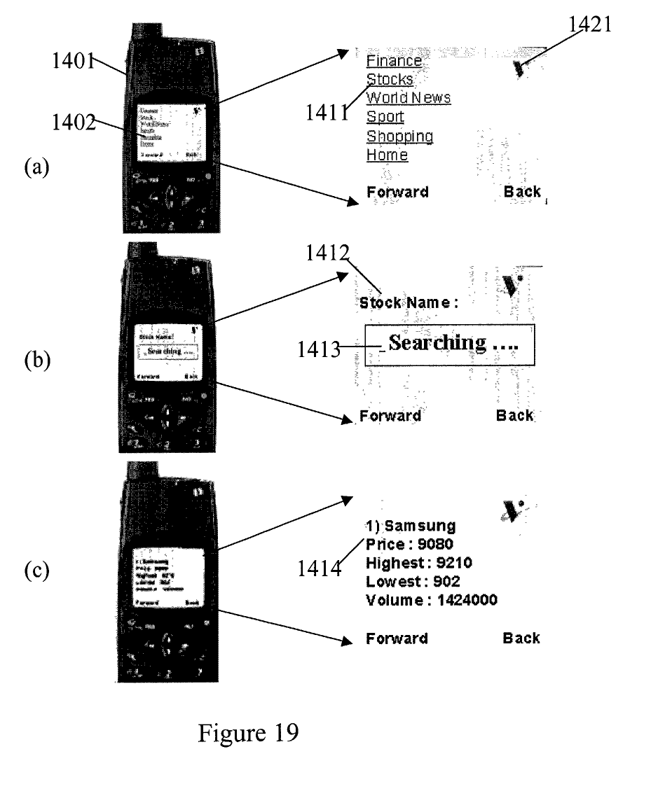

FIG. 19 illustrates an example of the present invention in operation. FIG. 14(a) shows the screen display 1402 of a mobile phone 1401 depicting a menu of choices 1411: Finance, Stocks, World News, Sport, Shopping, Home. A “V” symbol 1421 denotes a voice input-ready mode. The user chooses from menu 1411 by saying “stock”. FIG. 14(b) shows a prompt 1412 for the stock name. The user says “Samsung” and display 1402 shows “Searching . . . ”. Upon locating the desired information regarding Samsung's stock, it is displayed 1414 as “1) Samsung, Price: 9080, Highest: 9210, Lowest 9020, and Volume: 1424000”.

In an embodiment of the present invention, the sites and sub-sites of network communications system can add speech recognition access capability by utilizing a mirroring voice portal of portals according to the present invention. In a communications network, such as the Internet and the World Wide Web or a corporate intranet or extranet, there are a plurality of sites each having a site map and a plurality of sub-sites. A site map table, compiled in site map 602 (FIG. 6), maps the site maps at the plurality of sites. A mirroring means, coupled to the site map table, mirrors the site map at the site map at the plurality of sites to said site map table. A speech recognition means recognizes an input speech designating one of said plurality of sites and sub-sites; and a series of child processes launch the designated sites and sub-sites responsive to the spoken site and sub-site names. Then a content query is spoken and another child process launches the content from the selected sub-site. The mirroring can be done either at the website or at a central location of the speech recognition application provider. The system operates by simply mirroring the sites and sub-sites onto a speech recognition system site map, speaking a query for one of the plurality of mirrored sites and sub-sites, generating a child process to launch a site responsive to the spoken query, for example if a user desires to access Yahoo™, he does so by speaking “Yahoo” and the child process will launch the Yahoo site. If the user wants financial information, he speaks “finance” and the Yahoo finance sub-site is launched by the child process. Then, for example, a query for a given stock “Motorola” is spoken, the statistics for Motorola stock is launched by the child process and displayed for the user. Since all the sites can be accessed by voice utilizing the present invention, it is a voice portal of portals. Further, an efficient charging and payment method may be utilized. For each speech recognition session, the user is charged by either the speech recognition provider or the network communications service provider. If the latter, then the speech recognition access of sites may be added to a monthly bill.

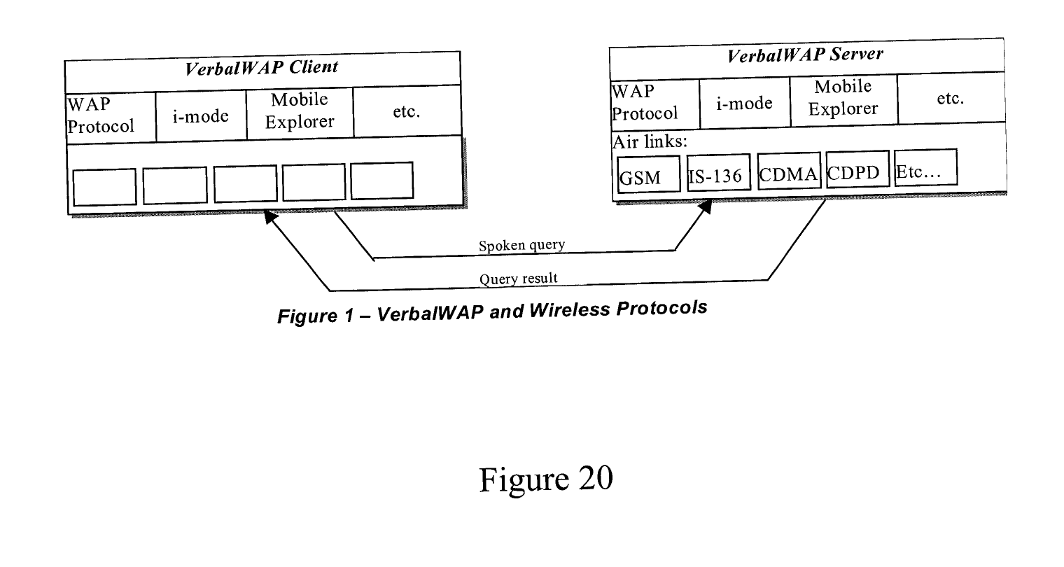

Data generated by client devices can be transmitted utilizing any present wireless protocol and can be made compatible with almost any future wireless protocol. FIG. 20 shows the communication between the client and server for various protocols according to the present invention. WAP protocol, i-mode, Mobile Explorer, and other wireless transmission protocols can be advantageously utilized. The air links include GSM, IS-136, CDMA, CDPD, and other wireless communication systems. As long as such protocols and systems are available at the client and the server, the present invention is utilizable as add-on software at the client and server thereby achieving complete compatibility with protocol and system.

While the above is a full description of the specific embodiments, various modifications, alternative constructions and equivalents may be used. For example, although Wireless Application Protocol (WAP) is utilized in the examples, any kind of wireless communication system and non-wireless or hardwired system are within the contemplation of the present invention, and the various trademarked names could just as easily be substituted for with, for example, “VerbalNET” to emphasize that speech recognition on any network communication system, including the Internet, intranets, extranets, and homenets, is within the scope of the implementations of this invention. Therefore, the above description and illustrations should not be taken as limiting the scope of the present invention which is defined by the following claims.

What is claimed is:

1. A speech recognition server system for implementation in a communications network having a plurality of clients, at least one site server, at least one gateway server, and at least one content server, said speech recognition server system comprising:
a site map including a table of site address words;
a server daemon, communicable with the gateway server and the site server, for managing client information and request parameters;
a voice recognition server, communicable with said server daemon, for speech recognition of the speech information;
a site map manager, communicable with said site map, for speech recognition of the site address words in said site map;
a speaker model, communicable with said site map manager and said voice recognition server, for speech recognition of the site address words in said site map; and
a site selector, communicable with said voice recognition server, said server daemon, and said site map, for selecting the site words responsive to words recognized by said voice recognition server.

2. The speech recognition server system of claim 1 wherein the clients comprise telephone handsets.

3. The speech recognition server system of claim 2 wherein the telephone handsets comprise wireless mobile phones.

4. The speech recognition server system of claim 1 wherein the clients include computers.

5. The speech recognition server system of claim 1 wherein the clients include personal digital assistant devices.

6. The speech recognition server system of claim 1 wherein the network communications system is a wireless system.

7. The speech recognition server system of claim 1 wherein the gateway server is a wireless application protocol (WAP) gateway.

8. The speech recognition server system of claim 1 wherein the site sever is a HTTP server.

9. The speech recognition server system of claim 1 wherein said site address table comprises URL website words.

10. The speech recognition server system of claim 1 wherein said speaker model is speaker dependent.

11. The speech recognition server system of claim 1 wherein said speaker model is speaker adaptive.

12. The speech recognition server system of claim 1 wherein said server daemon comprises:
a request manager for receiving information requests and user addresses from the clients and transmitting the information requests to said voice recognition server for speech recognition;
an ID manager, coupled to said request manager, for generating a user ID for each client and for transmitting a map page number to said sitemap manager;
a profile manager, coupled to said request manager, for receiving the user ID and matching a voice profile created by said voice recognition server;
a log manager, coupled to said request manager, for recording a log entry transmitted by said request manager;
a site address verifier, coupled to said ID manager, for receiving a matched site address from said site map manager and verifying the matched site address;
a reply manager, coupled to said request manager and to said site address verifier, for receiving the matched site address from said site address verifier and transmitting a fetch request to the site communications server responsive to the matched site address; and
a sessions manager, coupled to said request manager, for recording and controlling the sequence of actions.

13. The speech recognition server system of claim 12 wherein said site addresses are URLs.

14. The speech recognition server system of claim 12 wherein said profile manager requests said voice recognition server to generate an adaptation acoustic profile responsive to the user ID and transmits the adaptation acoustic profile to said profile manager.

15. The speech recognition server system of claim 1 wherein said voice recognition server comprises:
at least one voice recognition engine; and
a syllable map having map entries, coupled to said voice recognition engine, for matching an incoming voice feature with said map entries in said syllable map.

16. The speech recognition server system of claim 15 wherein said at least one voice recognition engine comprises a speaker-independent speech recognition program.

17. The speech recognition server system of claim 16 wherein said speaker-independent speech recognition program comprises words in a Korean language.

18. The speech recognition server system of claim 16 wherein said speaker-independent speech recognition program comprises words in a Japanese language.

19. The speech recognition server system of claim 16 wherein said speaker-independent speech recognition program comprises words in a Chinese language.

20. The speech recognition server system of claim 15 wherein said at least one voice recognition engine comprises an adaptive speech recognition program.

21. The speech recognition server system of claim 20 wherein said adaptive speech recognition program comprises words in a Korean language.

22. The speech recognition server system of claim 20 wherein said adaptive speech recognition program comprises words in a Japanese language.

23. The speech recognition server system of claim 20 wherein said adaptive speech recognition program comprises words in a Chinese language.

24. The speech recognition server system of claim 15 wherein said at least one voice recognition engine comprises a training speech recognition program.

25. The speech recognition server system of claim 24 wherein said training speech recognition program comprises words in a Korean language.

26. The speech recognition server system of claim 24 wherein said training speech recognition program comprises words in a Japanese language.

27. The speech recognition server system of claim 24 wherein said training speech recognition program comprises words in a Chinese language.

28. The speech recognition server system of claim 15 wherein said at least one voice recognition engine comprises a predetermined purpose speech recognition program.

29. The speech recognition server system of claim 28 wherein said predetermined purpose speech recognition program comprises words in a Korean language.

30. The speech recognition server system of claim 28 wherein said predetermined purpose speech recognition program comprises words in a Japanese language.

31. The speech recognition server system of claim 28 wherein said predetermined purpose speech recognition program comprises words in a Chinese language.

32. The speech recognition server system of claim 28 wherein said predetermined purpose speech recognition program includes site names on a communications network.

33. The speech recognition server system of claim 28 wherein said predetermined purpose speech recognition program includes company names on a stock exchange.

34. The speech recognition server system of claim 28 wherein said predetermined purpose speech recognition program includes transportation information related words.

35. The speech recognition server system of claim 28 wherein said predetermined purpose speech recognition program includes entertainment information related words.

36. The speech recognition server system of claim 28 wherein said predetermined purpose speech recognition program includes restaurant information words.

37. The speech recognition server system of claim 28 wherein said predetermined purpose speech recognition program includes weather information words.

38. The speech recognition server system of claim 28 wherein said predetermined purpose speech recognition program includes retail store name words.

39. The speech recognition server system of claim 28 wherein said predetermined purpose speech recognition program includes banking services related words.

40. The speech recognition server system of claim 28 wherein said predetermined purpose speech recognition program includes financial services related words.

41. The speech recognition server system of claim 28 wherein said predetermined purpose speech recognition program includes e-commerce and e-business related words.

42. The speech recognition server system of claim 28 wherein said predetermined purpose speech recognition program includes navigation aids words.

43. The speech recognition server system of claim 1 wherein said sitemap manager comprises:
a syllable generator for generating speech syllables;
a syllable map, coupled to said syllable generator, for storing site name words;
a site address map for storing site addresses;
a sitemap toolkit, coupled to said syllable generator, said sitemap toolkit including a user interface for interfacing with the contents server, a syllable map manager for managing the syllables transmitted from said syllable map and the syllables generated by said syllable generator, and a site address map manager for managing the site address words, said sitemap tool kit for matching the syllables from said syllable map and said syllables recognized by said voice recognition server.

44. The speech recognition server system of claim 43 wherein said site addresses comprise URL words.

45. The speech recognition server system of claim 43 wherein said syllable map comprises words in a Korean language.

46. The speech recognition server system of claim 43 wherein said syllable map comprises words in a Japanese language.

47. The speech recognition server system of claim 43 wherein said syllable map comprises words in a Chinese language.

48. The speech recognition server system of claim 43 wherein said syllable generator generates Korean language syllables.

49. The speech recognition server system of claim 43 wherein said syllable generator generates Korean language syllables.

50. The speech recognition server system of claim 43 wherein said syllable generator generates Japanese language syllables.

51. The speech recognition server system of claim 43 wherein said syllable generator generates Chinese language syllables.

52. A speech recognition server system for implementation in a communications network having at least one site server, at least one gateway server, at least one content server, and a plurality of clients each having a keypad and a micro-browser, said speech recognition server system comprising:
a hotkey, disposed on the keypad, for initializing a voice session;
a vocoder for generating voice frame data responsive to an input speech;
a client speech subroutine, coupled to said vocoder, for performing speech feature extraction on said voice frame data and to generate digitized voice signals therefrom;
a system-specific profile database for storing and transmitting system-specific client profiles;
a payload formatter, communicable with said client speech subroutine and said system-specific profile database, for formatting a client payload data flow received from said client speech subroutine with data received from said system-specific profile database;
a speech recognition server, communicable with the gateway server for speech recognition of the formatted client payload;
a transaction protocol (TP) socket, communicable with said payload formatter and the gateway server, for receiving the formatted client payload from said payload formatter, converting the client payload to a wireless speech TP query, and transmitting the wireless speech TP query via the gateway server through the communications network to said speech recognition server, and further for receiving a recognized wireless speech TP query from said speech recognition server, converting the recognized wireless speech TP query to a resource identifier, and transmitting the resource identifier to the micro-browser for identifying the resource responsive to the resource identifier;
a wireless transaction protocol socket, communicable with the micro-browser and gateway server, for receiving the resource query from the micro-browser, generating a wireless session resource query, and transmitting the resource query via the gateway server and through the communications network to the contents server, and further for receiving content from the content server via the site server, the communications network, and the gateway server, and transmitting the content via the micro-browser to the client for display; and
an event handler, communicable with said hotkey, said client speech subroutine, said TP socket, the micro-browser, and said payload formatter, for transmitting event command signals and synchronizing the voice session thereamong.

53. A speech recognition server system for implementation in a communications network having at least one site server, at least one gateway server, at least one content server, and a plurality of clients each having a keypad and a micro-browser, said speech recognition server system comprising:
a hotkey, disposed on the keypad, for initializing a voice session;
a vocoder for generating voice frame data responsive to an input speech;
a client speech subroutine, coupled to said vocoder, for performing speech feature extraction on said voice frame data and to generate digitized voice signals therefrom;
a system-specific profile database for storing and transmitting system-specific client profiles;
a payload formatter, communicable with said client speech subroutine and said system-specific profile database, for formatting the client payload received from said client speech subroutine with data received from said system-specific profile database;
a speech recognition server, communicable with the gateway server for speech recognition;
a transaction protocol (TP) socket, communicable with said payload formatter and the gateway server, for receiving the client payload from said payload formatter, converting the client payload to a TP tag, and transmitting the TP tag via the gateway server through the communications network to said speech recognition server;
a wireless transaction protocol socket, communicable with the micro-browser and the gateway server, for receiving a wireless push transmission from the gateway server responsive to a push access protocol transmission from said speech recognition server, and for receiving a resource transmission from the micro-browser and transmitting the resource transmission via the gateway server through the communications network to the site server, and further for receiving content from the content server via the site server, the communications network, and the gateway server, and transmitting the content via the micro-browser to the client for display; and
an event handler, communicable with said hotkey, said client speech subroutine, the micro-browser, and said payload formatter, for transmitting event command signals and synchronizing the voice session thereamong.

54. A speech recognition server system for implementation in a communications network having at least one site server, at least one gateway server, at least one contents server, and a plurality of clients each having a keypad and a micro-browser, said speech recognition server system comprising:
a hotkey, disposed on the keypad, for initializing a voice session;
a vocoder for generating voice frame data responsive to an input speech;
a client speech subroutine, coupled to said vocoder, for performing speech feature extraction on said voice frame data and to generate digitized voice signals therefrom;
a system-specific profile database for storing and transmitting system-specific client profiles;
a payload formatter, communicable with the micro-browser, said client speech subroutine and said system-specific profile database, for formatting a client payload received from said client speech subroutine with data received from said system-specific profile database;
a speech recognition server, communicable with the gateway server for receiving the client payload hypertext TP transmissions from the gateway server and for performing speech recognition on the client payload, and further for transmitting a recognized client payload to the gateway server;
a wireless transaction protocol socket, communicable with the micro-browser and the gateway server, for receiving a wireless query transmission from the micro-browser and transmitting a wireless session protocol transmission to the gateway server and thence to said speech recognition server, and further for receiving a wireless session protocol transmission from the gateway server responsive to a hypertext TP transmission from said speech recognition server, and for receiving a resource transmission from the micro-browser and transmitting the resource transmission via the gateway server through the communications network to the contents server, and further for receiving content from the content server via the site server, the communications network, and the gateway server, and transmitting the content via the micro-browser to the client for display; and
an event handler, communicable with said hotkey, said client speech subroutine, the micro-browser, and said payload formatter, for transmitting event command signals and synchronizing the voice session thereamong.

55. A speech recognition server system for implementation in a communications network having at least one site server, at least one gateway server, at least one content server, and a plurality of clients each having a keypad and a micro-browser, said speech recognition server system comprising:
a hotkey, disposed on the keypad, for initializing a voice session;
a vocoder for generating voice frame data responsive to an input speech;
a client speech subroutine, coupled to said vocoder, for performing speech feature extraction on said voice frame data and to generate digitized voice signals therefrom;
a system-specific profile database for storing and transmitting system-specific client profiles;
a payload formatter, communicable with the micro-browser, said client speech subroutine and said system-specific profile database, for formatting a client payload received from said client speech subroutine with data received from said system-specific profile database;
a speech recognition server, communicable with the gateway server for receiving the client payload hypertext TP transmissions from the gateway server and for performing speech recognition on the client payload, and further for transmitting a recognized client payload to the gateway server;
a wireless transaction protocol socket, communicable with the micro-browser, said payload formatter, and the gateway server, for receiving a wireless protocol query transmission from said payload formatter and transmitting a wireless session protocol transmission to the gateway server and thence to said speech recognition server, and further for receiving a wireless session protocol transmission from the gateway server responsive to a hypertext TP transmission from said speech recognition server, and for receiving a resource transmission from the micro-browser and transmitting the resource transmission via the gateway server through the communications network to the contents server, and further for receiving content from the content server via the site server, the communications network, and the gateway server, and transmitting the content via the micro-browser to the client for display; and
an event handler, communicable with said hotkey, said client speech subroutine, the micro-browser, and said payload formatter, for transmitting event command signals and synchronizing the voice session thereamong.

56. A distributed speech recognition system for implementation in a wireless mobile communications system, communicable with the Internet, having at least one website server, at least one wireless gateway proxy server, a wireless telephony applications (WTA) server, and a plurality of mobile communication devices each having a micro-browser, said distributed speech recognition system comprising:
a client speech processor, disposed in said mobile communication devices, for speech feature extraction; and
a server speech processor, disposed in the WTA server, for recognizing the speech features.

57. The distributed speech recognition system of claim 56 wherein said server speech processor is disposed in the wireless gateway proxy server.

58. The distributed speech recognition system of claim 56 wherein said server speech processor is disposed in the website server

59. A distributed speech recognition system for implementation in a wireless mobile communications system communicable with an intranet system having at least one web server, at least one intranet wireless communications gateway proxy server, a firewall, and a plurality of mobile communication devices, said distributed speech recognition system comprising:
a client speech processor, disposed in said mobile communication devices, for speech feature extraction; and
a server speech processor, disposed in the intranet wireless communications gateway proxy server for recognizing the speech features.

60. The distributed speech recognition system of claim 59 wherein said server speech processor is disposed in the web server.

61. A speech recognition server system for implementation in a communications network having a plurality of sites each having a site map and a plurality of sub-sites, said speech recognition server system comprising:
a site map table for mapping the site map at the plurality of sites;
mirroring means, coupled to said site map table, for mirroring the site map at the plurality of sites to said site map table;
speech recognition means for recognizing an input speech selecting one of said plurality of sites and sub-sites; and
first child process means, coupled to said speech recognition means, for launching one of the plurality of sites responsive to the input speech;
second child process means, coupled to said speech recognition means, for launching one of the plurality of sub-sites responsive to the input speech; and
third child process means, coupled to said speech recognition means, for launching information at the sub-site responsive to an input query.

62. The speech recognition server system of claim 61 wherein said speech recognition server system is disposed at the plurality of sites.

63. In a network communication system including a plurality of sites and sub-sites each providing content, a method for speech-accessing the sites, sub-sites, and content comprising the steps of:
mirroring the sites and sub-sites onto a speech recognition system site map;
speaking a selected site name for one of the plurality of mirrored sites and sub-sites;
generating a first child process to launch a site responsive to said spoken site name;
speaking a sub-site name for one of the plurality of mirrored sub-sites;
generating a second child process to launch a sub-site responsive to said spoken sub-site name;
speaking a query for one of the plurality of mirrored sub-sites; and
generating a third child process to launch a content responsive to said spoken query.

64. In a network communication system including a plurality of sites and sub-sites, a method for charging a payment for speech-accessing the sites and sub-sites comprising the steps of:
(a) mirroring the sites and sub-sites onto a speech recognition system site map;
(b) speaking a site name for one of the plurality of mirrored sites and sub-sites;
(c) generating a first child process to launch a site responsive to said spoken site name;
(d) speaking a sub-site name for one of the plurality of mirrored sub-sites;
(e) generating a second child process to launch a sub-site responsive to said spoken sub-site name;
(f) speaking a query for one of the plurality of mirrored sub-sites;
(g) generating a third child process to launch a content responsive to said spoken query; and
(h) charging a payment for said steps (a) to (g).

65. The method of claim 64 wherein said charging a payment for said steps (a) to (g) is done by a billing by the network communications system.

66. The method of claim 65 wherein said billing by the network communications system is performed monthly.
